(19) United States
(12) Patent Application Publication
(10) Pub. No.: US 2021/0129367 A1
(43) Pub. Date: May 6, 2021

(54) PUNCHING APPARATUS OF CHIP-ON-FILM AND ASSEMBLY SYSTEM OF DISPLAY APPARATUS

(71) Applicant: HKC CORPORATION LIMITED, Shenzhen City, Guangdong (CN)

(72) Inventors: Liang WANG, Shenzhen City (CN); Guanghui ZHANG, Shenzhen City (CN)

(73) Assignee: HKC Corporation Limited, Shenzhen City, Guangdong (CN)

(21) Appl. No.: 17/041,561

(22) PCT Filed: Nov. 30, 2018
(86) PCT No.: PCT/CN2018/118659

§ 371 Date: Sep. 25, 2020

(30) Foreign Application Priority Data
Nov. 16, 2018 (CN) 201811365897.2

(51) Int. Cl. B26D 5/32; B26D 7/27; B26F 1/44

(52) U.S. Cl. CPC B26D 5/32; B26F 1/44; B26D 7/27

(57) ABSTRACT

The disclosure relates to a punching apparatus of chip-on-film, including: a rotary axis that is configured to be sleeved with a workpiece tray that is wrapped with a chip-on-film material strip, the workpiece tray being configured to include a mark structure having model information of a chip-on-film and rotate along with the rotary axis; a punching structure configured to pull and punch the chip-on film material strip; an identification structure configured to identify the mark structure to identify the model information of the chip-on-film. The disclosure also relates to a assembly system of display apparatus that includes the punching apparatus of chip-on-film.

### TECHNICAL FIELD

The disclosure relates to display technologies, particularly a punching apparatus of chip-on-film and an assembly system of display apparatus.

### BACKGROUND

The disclosure herein merely provides background information regarding the invention, and does not necessarily constitute prior art.

Chip-on-film is formed by packaging chips on flexible circuits. Normally, a roll of chip-on-film material strip has a plurality of chip-on-film, and chip-on-film are punched from the chip-on-film material strip when in need. Currently, a display panel of a display apparatus is normally connected to a drive circuit board via a chip-on-film, and, during the process of assembling the display apparatus, a single piece of chip-on-film is obtained from punching a chip-on-film material strip by a punching apparatus and then assembled with the display panel. In order to avoid a wrong model of a chip-on-film, before sleeving a workpiece tray wrapped with a chip-on-film material strip into the punching apparatus, the model of the chip-on-film will be inputted into a system for determination. But, because of human involvement of furnishing a workpiece tray after system comparison, it is likely that while a comparison of a model of a chip-on-film is a success, an operator might pick up a wrong chip-on-film workpiece tray in furnishing, or, while a comparison of a model of a chip-on-film returns an error, an operator might fail to notice the situation of the system determination and furnishes a chip-on-film workpiece tray with a wrong model into the punching apparatus, thereby assembling the chip-on-film of wrong model with the display panel, causing massive malassembly to display apparatus, resulting that the production costs are increased, and delaying the production cycles.

### SUMMARY

According to various embodiments of the disclosure, a punching apparatus of chip-on-film and an assembly system of display apparatus are provided.

A punching apparatus of chip-on-film includes:

a rotary axis configured to be sleeved with a workpiece tray being wrapped with a chip-on-film material strip, the workpiece tray is provided with a mark structure including model information of the chip-on-film, and the workpiece tray rotates along with the rotary axis;

a punching structure configured to pull and punch the chip-on material strip; and

an identification structure configured to identify the mark structure to identify the model information of the chip-on-film.

According to the punching apparatus of chip-on-film, after the workpiece tray is mounted on the rotary axis, the punching structure pulls and punches the chip-on-film material strip as the rotary axis rotates, and obtains a single piece of chip-on-film. Because of the mark structure provided on the workpiece tray, the mark structure including model information of a corresponding chip-on-film, and the punching apparatus having the identification structure, the identification structure can automatically identify the mark structure during the punching process so as to identify the model information of the chip-on-film punched, meaning the punching apparatus may automatically obtain the model information of the chip-on-film that is punched as the chip-on-film is being punched. The punching apparatus is communicatively connected to an assembly apparatus of display panel. The assembly apparatus of display panel obtains a chip-on-film punched by the punching apparatus of chip-on-film for assembly, while, at the same time, may obtain model information of the chip-on-film automatically identified by the punching apparatus to make a comparison to determine whether the model information of the chip-on-film being assembled is correct. In the disclosure, a model comparison is performed before mounting a chip-on-film workpiece tray, then a workpiece tray is mounted in a punching apparatus, and another automatic identification and comparison is performed during the assembling process. Because the punching apparatus during the punching process identifies a model of a chip-on-film and communicates the model information directly to an assembly equipment of display apparatus, without involving an operator during the process, a model of a chip-on-film will not be misidentified. Even if a wrong identification happens before mounting a workpiece tray, as an automatic identification procedure is provided during the assembling process, once the assembly equipment of display apparatus detects a wrong model after model comparison, a warning signal may be generated and the assembling is suspended, thereby preventing scrapping a lot of display apparatus due to a wrong model of a chip-on-film.

In an embodiment, the mark structure is provided on a front face of the workpiece tray, and the identification structure is opposite to the front face of the workpiece tray.

In another embodiment, the mark structure is completely within an identification range of the identification structure.

In another embodiment, the punching apparatus of chip-on-film further includes a reloading gate. The reloading gate is right opposite to the front face of the workpiece tray when the reloading gate is closed, and the identification structure is provided on the reloading gate.

In another embodiment, the mark structure is a tag attached to the workpiece tray.

In another embodiment, the tag includes a barcode, the barcode includes the model information of the chip-on-film, the identification structure includes a code reader configured to read the barcode to identify the model information of the chip-on-film.

In another embodiment, the tag includes a plurality of barcodes, one of the plurality of barcodes includes the model information of the chip-on-film, the code reader is provided with a selecting function, and the code reader is configured to select the barcode including the model information of the chip-on-film from the plurality of barcodes and obtain the model information of the chip-on-film.

In another embodiment, the mark structure includes a plurality of barcodes having different lengths, one of the plurality of barcodes includes the model information of the chip-on-film, the code reader is configured to select and read the barcode including the model information of the chip-on-film by comparing the lengths and identify the model information of the chip-on-film via the read barcode.

In another embodiment, the plurality of barcodes include a barcode including a production date.

In another embodiment, the barcode having the model information of the chip-on-film has the longest length.

In another embodiment, the barcode having the model information of the chip-on-film has a length of 30 yards.

In another embodiment, the identification structure is configured to regularly identify the mark structure.

In another embodiment, the identification structure is configured to identify the mark structure when the marked unit is rotated to be within an identification range of the identification structure.

In another embodiment, an interval of the regular identification of the identification structure is one rotation of the workpiece.

In another embodiment, the punching structure includes a levelling structure, an aligning structure, and a cutting structure, the levelling structure is configured to pull out and level the chip-on-film material strip, the aligning structure is configured to obtain a cutting location of the chip-on-film material strip, and the cutting structure is configured to cut the chip-on-film material strip.

In another embodiment, the cutting structure is a laser light, and the chip-on-film material strip is cut by the cutting structure through laser cutting.

In another embodiment, the workpiece tray is annular.

A punching apparatus of chip-on-film includes:

a rotary axis configured to be sleeved with a workpiece tray being wrapped with a chip-on-film material strip, the workpiece tray includes a mark structure including model information of the chip-on-film, and rotates along with the rotary axis, the mark structure includes a plurality of barcodes having different lengths, and one of the plurality of barcodes includes the model information of the chip-on-film;

a punching structure configured to pull and punch the chip-on-film material strip;

a code reader configured to regularly identify the mark structure, the code reader is configured to select and read a barcode having model information of chip-on-film by comparing the lengths, the code reader is configured to identify the model information of the chip-on-film via the read barcode.

According to the punching apparatus of chip-on-film, during the punching process, the code reader inside the punching apparatus can automatically identify a barcode of the mark structure so as to identify the model information of the chip-on-film punched. The punching apparatus can be communicatively connected to an assembly apparatus of display panel. The display apparatus assembles display panels and chip-on-film, while at the same time, may obtain model information of the chip-on-film identified by the punching apparatus to make a comparison between the identified model of the chip-on-film and the prestored model of the chip-on-film in order to determine whether the model of the chip-on-film being assembled is correct. Once the assembly equipment of display apparatus detects an error in the model after model comparison, a warning signal may be generated and the assembling is suspended, thereby preventing scrapping a lot of display apparatus due to a wrong model of a chip-on-film. Also the code reader may quickly and precisely select the barcode having the model information of the chip-on-film from the plurality of barcodes by way of length comparing, and by regularly identifying the mark structure, the power consumption may be reduced.

An assembly system of display apparatus includes:

a server having prestored therein model information of a chip-on-film matching a display panel;

a punching apparatus of chip-on-film, including:

a rotary axis configured to be sleeved with a workpiece tray being wrapped with a chip-on-film material strip, the workpiece tray includes a mark structure including the model information of the chip-on-film, and rotates along with the rotary axis;

a punching structure configured to pull and punch the chip-on material strip; and

an identification structure configured to identify the mark structure to identify the model information of the chip-on-film;

an assembly equipment of display apparatus includes:

an assembly platform configured to assemble a display panel and a chip-on-film, the chip-on-film is a chip-on-film that is punched by the punching apparatus of chip-on-film; and

a control structure communicatively connected to the server and the punching apparatus of chip-on-film, configured to obtain and compare the prestored model information of the chip-on-film in the server and the model information of the chip-on-film identified by the punching apparatus of chip-on-film, and to produce a warning signal when the prestored model information of the chip-on-film does not match the identified model information of the chip-on-film.

The assembly system of display apparatus includes the punching apparatus of chip-on-film configured to punch the chip-on-film material strip and provide the chip-on-film to the assembly equipment of display apparatus, also, during the process of punching the chip-on-film material strip, to automatically identify the model of the chip-on-film communicated to the assembly equipment of display apparatus. The assembly equipment of display apparatus, for one thing, obtains the identified model information of the chip-on-film by the punching apparatus of chip-on-film, for another thing, obtains the prestored model information of the needed chip-on-film in the server, and compares these two model information, and, upon finding a wrong model, issues a warning signal and suspend the assembling to prevent misassembly in a lot of display apparatus.

In another embodiment, the control structure is communicatively connected to the identification structure.

### BRIEF DESCRIPTION OF THE DRAWINGS

To better illustrate and describe the embodiments and/or examples of the disclosure, reference can be made to one or more figures. The accompanying details or examples for describing the figures should not be understood as limiting the scope of any of: the disclosure, the embodiments and/or illustrations, or the best mode of the invention as currently understood.

FIG. 1 is a schematic view of a punching apparatus of a chip-on-film according to an embodiment.

FIG. 2 is a schematic view of the relative position of a mark structure and an identification structure according to an embodiment.

FIG. 3 is a block diagram of the structure of an assembly equipment of display apparatus according to an embodiment.

FIG. 4 is an illustrative view showing the structure of an assembly equipment of display apparatus according to another embodiment.

### DETAILED DESCRIPTION OF THE EMBODIMENTS

The invention is described in detail hereinafter with reference to accompanying drawings whereby a preferred embodiment of the disclosure is provided. However, the invention may be embodied in many different forms and should not be construed as limited to the embodiments set forth herein. Rather, these embodiments are provided so that this disclosure will be more thorough and complete.

Unless otherwise defined, all terms (including technical and scientific terms) used herein have the same meaning as commonly understood by a reasonable person with ordinary skills in the art. The terms used by the disclosure of the invention are only intended for illustrating detailed embodiments, and are not intended for limiting the invention. As used herein, the term “and/or” includes any and all combinations of one or more of the associated listed items.

As used herein, it is understood that, oriental or positional relationships that are instructed by terms “above,” “below,” “vertical,” “horizontal,” “inner,” “outer,” and the like, are based on the methods or positional relationships as illustrated by the accompanying figures, and are merely intended for illustrating the invention and simplifying the description, and are not intended to express or imply that the associated device or component must have a specific orientation, be formed and operated in a specific orientation, and should not be considered as limiting the invention.

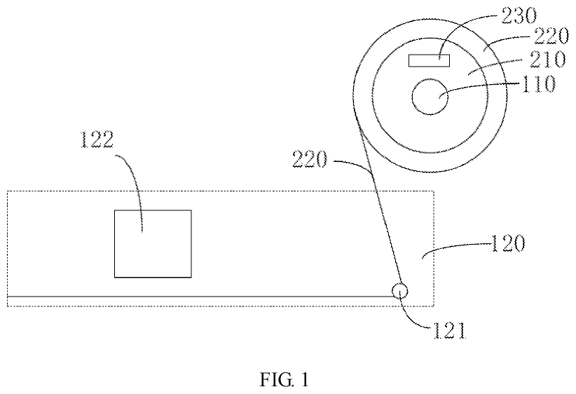

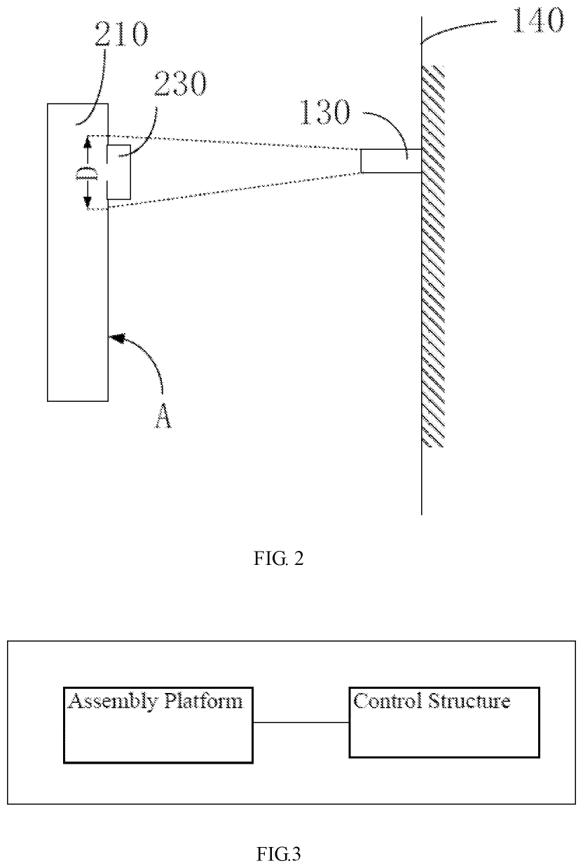

Referring to FIGS. 1 and 2, in an embodiment, a punching apparatus of chip-on-film includes a rotary axis 110, a punching structure 120, and an identification structure 130. The rotary axis 110 is configured to be sleeved with a workpiece tray 210. The workpiece tray 210 is wrapped with a chip-on-film material strip 220. A mark structure 230 is provided on the workpiece tray. The mark structure 230 includes model information corresponding to the chip-on-film wrapping the workpiece tray. The punching structure 120 is configured to pull the chip-on-film material strip 220 on the workpiece tray and punch the chip-on-film material strip to obtain a single piece of chip-on-film. The identification structure 130 is configured to identify the mark structure 230 to identify the model information of the chip-on-film 230. When the mark structure 230 is within an identification range of the identification structure 130, the identification structure 130 can identify the mark content of the mark structure to identify the model information of the chip-on-film.

In the disclosure, after the workpiece tray is mounted on the rotary axis of the punching apparatus of chip-on-film, the punching structure pulls out and punches the chip-on-film material strip as the rotary axis rotates to obtain a single piece of chip-on-film. During the punching process, the identification structure inside the punching apparatus can automatically identify the mark structure to identify the model information of the chip-on-film punched, i.e., the punching apparatus can automatically obtain the model information of the chip-on-film punched during the process of punching the chip-on-film. The punching apparatus may be communicatively connected to an assembly equipment of display apparatus, when assembling the display chip-on-film and the display panels, by obtaining the model information of the chip-on-film identified by the punching apparatus, the assembly equipment of display apparatus compares the identified model information of the chip-on-film with a prestored model of the chip-on-film to determine whether the model of the chip-on-film being assembled is correct. In the disclosure, a model comparing is performed before the chip-on-film workpiece tray is mounted on the punching apparatus, and during the assembling process an automatic identification and comparing is again performed. Since the punching apparatus identifies the model of the chip-on-film during the punching process and communicates the model information directly to the assembly equipment of display apparatus without involving an operator during the process, as a result, the model of the chip-on-film will not be misidentified. Even if a misidentification would happen before the workpiece tray is mounted, as an automatic identification procedure is provided during the assembling process, once the assembly equipment of display apparatus detects a wrong model after model comparing, a warning signal may be issued and the assembling is suspended, thereby preventing scrapping a lot of display apparatuses due to wrong model of the chip-on-film.

In an embodiment, the punching structure 120 has a levelling structure 121, an aligning structure, and a cutting structure 122. The chip-on-film material strip is first pulled out and then spread and levelled by the levelling structure 121, a cutting position is obtained by the aligning structure, and a precise cutting is performed via the cutting structure 122. In an embodiment, the cutting structure 122 may be a laser light, and the chip-on-film material strip is cut by laser.

In an embodiment, the mark structure 230 is located on the front face of the workpiece tray 210. Normally, the workpiece tray is a hollow annulus. The workpiece tray has an outermost curved surface and an innermost curved surface and a flat surface connecting the two curved surfaces. The mark structure 230 is located within the flat surface. The surface where the mark structure 230 located is defined as the front face A, and the face opposite to the front face is defined as the back face. The identification structure 130 is located on a side opposite to the front face A, so as to facilitate the identification of the mark structure 230. In an embodiment, the identification structure 130 is right opposite to the mark unit 230. In other words, the identification range of the identification structure 130 is in front of the identification structure 130, and the mark structure 230 may be completely within the identification range D of the identification structure 130.

In an embodiment, the punching apparatus of chip-on-film includes a reloading gate 140. The punching apparatus is mounted with the workpiece tray at the reloading gate. After the workpiece tray is mounted, the reloading gate 140 is closed, and the closed reloading gate 140 is right opposite to the front face A of the workpiece tray 210, and the reloading gate 140 is right opposite to the workpiece tray 210 to facilitate the mounting of the workpiece tray. In another embodiment, the identification structure 130 is located on the reloading gate 140, and as the reloading gate 140 is right opposite to the front face A of the workpiece tray A, the identification structure 130 is arranged on the reloading gate 140, such that the identification structure 130 is right opposite to the front face A of the workpiece tray A, so as to facilitate the identification of the mark structure 230 of the workpiece tray.

In an embodiment, the mark structure 230 is a tag attached to the workpiece tray 210. The tag includes a barcode having model information of corresponding chip-on-film. The identification structure 130 is a code reader that reads the barcode to identify model information of a chip-on-film. By way of having the model information of chip-on-film recorded on the barcode and scanning the barcode, the model information of the chip-on-film may be obtained quickly and precisely.

In an embodiment, the mark structure 230 is a tag attached to the workpiece tray 210. The tag includes a plurality of barcodes, one of which is a target barcode having model information of a chip-on-film. Barcodes other than the target barcode may contain other product information such as the production date. The code reader is provided with a selecting function to select the target barcode from the plurality of barcodes to obtain the model information of the chip-on-film. In another embodiment, the code reader identifies the target barcode by length comparing, i.e., the tag has a plurality of barcodes that have different lengths and one of which with a specific length has the model information of the chip-on-film. Specifically, the code reader is configured to identify the lengths of barcodes, and scan the tag and select and read the target barcode by comparing the lengths of the barcodes, and identifies the model information of the chip-on-film by the target barcode. In another embodiment, the target barcode has the longest length in the tag, as when there are barcodes having longer lengths than the target barcode, the code reader may intercept some segments of other barcodes as the target barcode and have misidentification. In the embodiment, the length of the target barcode is set to be the longest in the tag to prevent a misidentification and improve the precision of the identification. For example, when the length of the target barcode is set to 30 yards, the length of the barcode read by the code reader is also set to 30 yards. The code reader in scanning will only read barcodes with a length of 30 yards and interprets and obtains the model information of the chip-on-film from the barcodes read.

In an embodiment, the identification structure 130 is configured to regularly identify the mark structure 230. In another embodiment, when the mark structure 230 is a barcode tag and the identification structure 130 is a code reader, the code reader regularly scans the tag. As the workpiece tray continuously rotates during the cutting process, the tag rotates along with the workpiece tray, while the position of the code reader is unchanged, the content on the tag is only scanned when the tag is rotated to be within an identification range of the code reader. Therefore, no real time scanning is needed, and only regular scanning is needed, thereby reducing the power consumption by the code reader. In another embodiment, an interval of the regular identification of the identification structure is one rotation of the workpiece, i.e., the identification is performed only when the mark structure is rotated to be within the identification range of the identification structure, thereby increasing the times of identifying the mark structure and reducing the power consumption by the identification structure.

The disclosure further relates to another punching apparatus of chip-on-film, which includes a rotary axis 110, a punching structure 120, and a code reader. The rotary axis 110 is sleeved with a workpiece tray 210 wrapped with a chip-on-film material strip 220. The workpiece tray 210 is provided with a mark structure 230 that has the model information of the chip-on-film and rotates along with the rotary axis 110. The mark structure 230 has a plurality of barcodes having different lengths, one of the plurality of barcodes has the model information of the chip-on-film. The punching structure 120 is configured to pull and punch the chip-on-film material strip 220. The code reader is configured to regularly identify the mark structure 230 and select and read the barcode having the model information of the chip-on-film by comparing the lengths, and is also configured to identify the model information of the chip-on-film via the read barcode.

According to the punching apparatus of chip-on-film, during the punching process, the code reader inside the punching apparatus can automatic identify the barcode of the mark structure to identify the model information of the chip-on-film punched. An assembly equipment of display panel may be communicatively connected to the punching apparatus, when assembling the chip-on-film and the display panels, the display apparatus may also obtain the model information of the chip-on-film identified by the punching apparatus and compare the identified model of the chip-on-film with a prestored model of the chip-on-film to determine whether the model of the chip-on-film being assembled is correct. As the punching apparatus during the punching process identifies the model of the chip-on-film and may communicate the model information directly to the assembly equipment of display apparatus without involving an operator during the process, as a result the model of the chip-on-film will not be misidentified. Even if a misidentification would happen before the workpiece tray is mounted, as an automatic identification procedure is provided in the assembling process, once the assembly equipment of display apparatus detects a wrong model after model comparing, a warning signal may be issued and the assembling is suspended, thereby preventing scrapping a lot of display apparatuses due to wrong model of the chip-on-film. Meanwhile, the barcode having the model information of the chip-on-film may be quickly and precisely selected from the plurality of barcodes by length comparing, and the mark structure is identified regularly, thereby reducing the power consumption by the code reader.

The disclosure also relates to an assembly equipment of display apparatus, as shown in FIG. 3, which includes an assembly platform and a control structure. The assembly platform is configured to assembly display panels and chip-on-films that are punched by the punching apparatus of chip-on-film. The detailed structure of the punching apparatus of chip-on-film is described above and is omitted for brevity. The control structure is configured to be communicatively connected to the punching apparatus of chip-on-film to obtain the model information of the chip-on-film identified by the punching apparatus of chip-on-film and compare the model information of the chip-on-film with a prestored model information of the chip-on-film. The control structure is also configured to issue a warning signal when the prestored model information of the chip-on-film does not match the identified model information of the chip-on-film. The prestored model information of the chip-on-film shows the model information of the chip-on-film required by display panels to assemble. In another embodiment, the control structure specifically is communicatively connected to the identification structure of the punching apparatus to obtain the model information of the chip-on-film identified by the identification structure.

According to the assembly equipment of display apparatus, for one thing, the assembly platform is configured to assemble display panels and chip-on-films, for another thing, the control structure is configured to obtain the model information of the chip-on-film identified by the punching structure and compare the model information of the chip-on-film with the prestored model information of the chip-on-film, and compare and determine whether the model of the chip-on-film being assembled is correct, and upon detecting a wrong model, a warning signal is issued and the assembling is suspended.

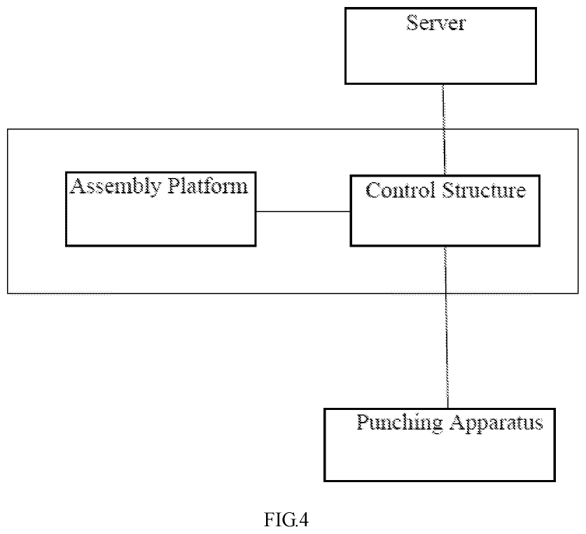

The disclosure also relates to an assembly system of display apparatus, as shown in FIG. 4, which includes a server, a punching apparatus of chip-on-film, and an assembly equipment of display apparatus. The server has prestored model information of the chip-on-film corresponding to the display panels to assemble. The punching apparatus of chip-on-film is the foregoing punching apparatus of chip-on-film whose specific structure is described and is omitted for brevity. The assembly equipment of display apparatus includes an assembly platform and a control structure. The display platform is configured to assembly display panels and chip-on-films. The chip-on-films are the chip-on-films punched by the foregoing punching apparatus of chip-on-film. The control structure is communicatively connected to the server and the punching apparatus of chip-on-film respectively, and is configured to obtain the prestored model information of the chip-on-film in the server and the information of the chip-on-film identified by the punching apparatus for comparison. The control structure is also configured to issue a warning signal when the prestored model information of the chip-on-film does not match the identified model information of the chip-on-film. In another embodiment, the control structure specifically is communicatively connected to the identification structure of the punching apparatus to obtain the model information identified by the identification structure.

According to the assembly system of display apparatus, the punching apparatus of chip-on-film is configured to punch the chip-on-film material strip to provide chip-on-films to the assembly equipment of display apparatus, and to automatically identify the model of the chip-on-film and transmit the model of the chip-on-film to the assembly equipment of display apparatus. The assembly equipment of display apparatus, for one thing, obtains the model information of the chip-on-film identified by the punching apparatus of chip-on-film, for another thing, obtains the prestored model information of the required chip-on-film in the server, and compare the two model information, and issues a warning signal upon detecting a wrong model and suspends the assembling, thereby preventing misassembly in a lot of display apparatuses.

The foregoing respective technical features involved in the respective embodiments can be combined arbitrarily, for brevity, not all possible combinations of the respective technical features in the foregoing embodiments are described, however, to the extent they have no collision with each other, the combination of the respective technical features shall be considered to be within the scope of the description.

The foregoing implementations are merely specific the embodiment of the present disclosure, and are not intended to limit the protection scope of the present disclosure. It should be noted that any variation or replacement readily figured out by persons skilled in the art within the technical scope disclosed in the present disclosure shall all fall into the protection scope of the present disclosure. Therefore, the protection scope of the present disclosure shall be subject to the protection scope of the claims.

1. A punching apparatus of chip-on-film, comprising:
a rotary axis configured to be sleeved with a workpiece tray being wrapped with a chip-on-film material strip, wherein the workpiece tray is provided with a mark structure comprising model information of the chip-on-film, and the workpiece tray rotates along with the rotary axis;
a punching structure configured to pull and punch the chip-on-film material strip; and
an identification structure configured to identify the mark structure to identify the model information of the chip-on-film.

2. The punching apparatus according to claim 1, wherein the mark structure is provided on a front face of the workpiece tray, wherein the identification structure is opposite to the front face of the workpiece tray.

3. The punching apparatus according to claim 2, wherein the mark structure is completely within an identification range of the identification structure.

4. The punching apparatus according to claim 2, further comprising a reloading gate, the reloading gate is right opposite to the front face of the workpiece tray when the reloading gate is closed, wherein the identification structure is provided on the reloading gate.

5. The punching apparatus according to claim 1, wherein the mark structure is a tag attached to the workpiece tray.

6. The punching apparatus according to claim 5, wherein the tag comprises a barcode, the barcode comprises the model information of the chip-on-film, wherein the identification structure comprises a code reader configured to read the barcode to identify the model information of the chip-on-film.

7. The punching apparatus according to claim 6, wherein the tag comprises a plurality of barcodes, one of the plurality of barcodes comprises the model information of the chip-on-film, wherein the code reader is provided with a selecting function, and the code reader is configured to select the barcode comprising the model information of the chip-on-film from the plurality of barcodes and obtain the model information of the chip-on-film.

8. The punching apparatus according to claim 7, wherein the mark structure comprises a plurality of barcodes having different lengths, one of the plurality of barcodes comprises the model information of the chip-on-film, wherein the code reader is configured to select and read the barcode comprising the model information of the chip-on-film by comparing the lengths and identify the model information of the chip-on-film via the read barcode.

9. The punching apparatus according to claim 7, wherein the plurality of barcodes comprise a barcode comprising a production date.

10. The punching apparatus according to claim 8, wherein the barcode comprising the model information of the chip-on-film has the longest length.

11. The punching apparatus according to claim 10, wherein the barcode comprising the model information of the chip-on-film has a length of 30 yards.

12. The punching apparatus according to claim 1, wherein the identification structure is configured to regularly identify the mark structure.

13. The punching apparatus according to claim 12, wherein the identification structure is configured to identify the mark structure when the marked structure is rotated to be within an identification range of the identification structure.

14. The punching apparatus according to claim 12, wherein an interval of the regular identification of the identification structure is one rotation of the workpiece.

15. The punching apparatus according to claim 1, wherein the punching structure comprises a levelling structure, an aligning structure, and a cutting structure, the levelling structure is configured to pull out and level the chip-on-film material strip, the aligning structure is configured to obtain a cutting location of the chip-on-film material strip, and the cutting structure is configured to cut the chip-on-film material strip.

16. The punching apparatus according to claim 15, wherein the cutting structure is a laser light, and the chip-on-film material strip is cut by the cutting structure through laser cutting.

17. The punching apparatus according to claim 1, wherein the workpiece tray is annular.

18. A punching apparatus of chip-on-film, comprising:
a rotary axis configured to be sleeved with a workpiece tray being wrapped with a chip-on-film material strip, the workpiece tray comprises a mark structure comprising model information of the chip-on-film, and rotates along with the rotary axis, wherein the mark structure comprises a plurality of barcodes having different lengths, and one of the plurality of barcodes comprises the model information of the chip-on-film;
a punching structure configured to pull and punch the chip-on-film material strip;
a code reader configured to regularly identify the mark structure, wherein the code reader is configured to select and read a barcode having model information of chip-on-film by comparing the lengths, the code reader is configured to identify the model information of the chip-on-film via the read barcode.

19. An assembly system of display apparatus, comprising:
a server having prestored therein model information of a chip-on-film matching a display panel;
a punching apparatus of chip-on-film, comprising:
a rotary axis configured to be sleeved with a workpiece tray being wrapped with a chip-on-film material strip, wherein the workpiece tray comprises a mark structure comprising the model information of the chip-on-film, and rotates along with the rotary axis;
a punching structure configured to pull and punch the chip-on film material strip; and
an identification structure configured to identify the mark structure to identify the model information of the chip-on-film;
an assembly equipment of display apparatus, comprising:
an assembly platform configured to assemble a display panel and a chip-on-film, wherein the chip-on-film is a chip-on-film that is punched by the punching apparatus of chip-on-film; and
a control structure communicatively connected to the server and the punching apparatus of chip-on-film, configured to obtain and compare the prestored model information of the chip-on-film in the server and the model information of the chip-on-film identified by the punching apparatus of chip-on-film, and to issue a warning signal when the prestored model information of the chip-on-film does not match the identified model information of the chip-on-film.

20. The assembly system according to claim 19, wherein the control structure is communicatively connected to the identification structure.
